(19) United States
(12) Patent Application Publication
(10) Pub. No.: US 2025/0187402 A1
(43) Pub. Date: Jun. 12, 2025

(54) VEHICLE HVAC SYSTEM AND METHOD FOR CONTROLLING THE SAME

(71) Applicants: HYUNDAI MOTOR COMPANY, Seoul (KR); KIA CORPORATION, Seoul (KR)

(72) Inventors: Tae Woong Lim, Hwaseong-si (KR); Kyu Ho Chae, Seoul (KR); Won Bin Jeong, Hwaseong-si (KR); Jun Ho Baek, Ansan-si (KR); Dong Myeong Lee, Incheon (KR); Gyoung Wan Koo, Incheon (KR)

(73) Assignees: HYUNDAI MOTOR COMPANY, Seoul (KR); KIA CORPORATION, Seoul (KR)

(21) Appl. No.: 18/743,846

(22) Filed: Jun. 14, 2024

(30) Foreign Application Priority Data
Dec. 8, 2023 (KR) 10-2023-0178071

(51) Int. Cl. B60H 1/32; B60H 1/00

(52) U.S. Cl. CPC B60H 1/3205; B60H 1/0073; B60H 1/00892; B60H 2001/3238; B60H 2001/325; B60H 2001/3261; B60H 2001/3267

(57) ABSTRACT

A vehicle heating, ventilation, and air conditioning (HVAC) system includes: a compressor; an interior condenser located on the downstream side of the compressor and disposed in an HVAC case; a heating-side expansion valve located on the downstream side of the interior condenser; a water-cooled heat exchanger located on the downstream side of the heating-side expansion valve; and a controller. The controller is configured to adjust an opening degree of the heating-side expansion valve based on a temperature difference between air flowing from the interior condenser to front seats of a vehicle cabin and air flowing from the interior condenser to rear seats of the cabin. The controller is also configured to adjust the opening degree based on an amount of heat (heat release amount) transferred from the interior condenser to the air.

### CROSS-REFERENCE TO RELATED APPLICATION

This application is based on and claims the benefit of and priority to Korean Patent Application No. 10-2023-0178071, filed on Dec. 8, 2023, in the Korean Intellectual Property Office, the disclosure of which is incorporated herein in its entirety by reference.

### TECHNICAL FIELD

The present disclosure relates to a vehicle heating, ventilation, and air conditioning (HVAC) system and a method for controlling the same. More particularly, the present disclosure relates to a vehicle HVAC system and a method for controlling the same designed to adjust the opening degree of a heating-side expansion valve.

### BACKGROUND

With a growing interest in energy efficiency and environmental issues, there is a demand for the development of eco-friendly vehicles that can replace internal combustion engine vehicles. Such eco-friendly vehicles are classified into electric vehicles which are driven using fuel cells or electricity as a power source and hybrid vehicles which are driven using an engine and a battery.

Electric vehicles or hybrid vehicles may include a vehicle thermal management system for heating, ventilation, and air conditioning (HVAC) in a cabin (or passenger compartment). Additionally, the vehicle thermal management system may maintain a battery and/or power electronics (PE) components at appropriate temperatures. The vehicle thermal management system may include a HVAC system for HVAC in the cabin, a PE cooling system for maintaining the PE components at appropriate temperatures, and a battery cooling for maintaining the battery at an appropriate temperature.

To operate in a heating mode, the HVAC system may include a compressor, an interior condenser disposed on the downstream side of the compressor, a heating-side expansion valve disposed on the downstream side of the interior condenser, and a water-cooled heat exchanger disposed on the downstream side of the heating-side expansion valve. The interior condenser may be disposed in an HVAC case. As refrigerant passes through an internal passage of the interior condenser, and air passes by an exterior surface of the interior condenser, the air may be heated by the interior condenser.

In order to avoid operational limits caused by a decrease in pressure of the refrigerant, the interior condenser disposed in the HVAC case may be configured to allow the refrigerant to flow in one direction. Accordingly, the temperature of the air passing by the exterior surface of the interior condenser may differ depending on portions of the exterior surface of the interior condenser. For example, the interior condenser may have an inlet header located above an outlet header and may have a plurality of tubes may connect the inlet header and the outlet header. As the refrigerant flows from the inlet header to the outlet header through the plurality of tubes, the refrigerant may exchange heat with the air. Additionally, a temperature difference between the air passing by an upper portion of the interior condenser and the air passing by a lower portion of the interior condenser may occur. The air passing by the upper portion of the interior condenser may be directed toward the front seats of the vehicle cabin through an outlet of the HVAC case. The air passing by the lower portion of the interior condenser may be directed toward the rear seats of the cabin through a rear-seat duct. Thus, a temperature difference between the temperature of the air directed toward the front seats of the cabin and the temperature of the air directed toward the rear seats of the cabin may occur. Hereinafter, the term “temperature difference” is be used to mean the temperature difference between the temperature of the air flowing from the interior condenser to the front seats of the cabin and the temperature of the air flowing from the interior condenser to the rear seats of the cabin.

In a state in which the HVAC system operates in a heating mode, when the opening degree of the heating-side expansion valve increases, the flow resistance of the refrigerant may relatively decrease. Since a difference between a suction pressure (suction temperature) of the compressor and a discharge pressure (discharge temperature) of the compressor relatively decreases, the temperature and pressure of the refrigerant flowing into the interior condenser may decrease and the flow rate of the refrigerant into the interior condenser may increase. As the opening degree of the heating-side expansion valve increases, the amount of heat (heat release amount) transferred from the interior condenser to the air may relatively decrease. Additionally, as the flow rate of the refrigerant into the interior condenser increases, a difference between the temperature of the refrigerant flowing into the inlet header and the temperature of the refrigerant discharged from the outlet header may decrease. Accordingly, the temperature difference may be relatively reduced.

As the opening degree of the heating-side expansion valve increases, the heat release amount may relatively decrease. Accordingly, the cabin heating performance of the HVAC system may be reduced. As the opening degree of the heating-side expansion valve decreases, the heat release amount may relatively increase. Accordingly, the cabin heating performance of the HVAC system may be improved. In other words, the heat release amount and the cabin heating performance of the HVAC system may be inversely proportional to the opening degree of the heating-side expansion valve. In addition, as the opening degree of the heating-side expansion valve increases, the temperature of the air directed toward the rear seats of the cabin may relatively increase, resulting in a decrease in temperature difference. As the opening degree of the heating-side expansion valve decreases, the temperature of the air directed toward the rear seats of the cabin may relatively decrease, resulting in an increase in temperature difference. In other words, the temperature of the air directed toward the rear seats of the cabin may be proportional to the opening degree of the heating-side expansion valve, and the temperature difference may be inversely proportional to the opening degree of the heating-side expansion valve. The cabin heating performance and the temperature difference may conflict with each other depending on the opening degree of the heating-side expansion valve. Thus, the heating of the cabin may not be efficiently performed in heating conditions to reduce the temperature difference.

The above information described in this Background Section is provided to assist in understanding the background of the inventive concept. Thus, the information described in the Background Section may include any technical concept that is not considered as the prior art that is already known to those having ordinary skill in the art.

### SUMMARY

The present disclosure has been made to solve the above-mentioned problems occurring in the prior art while advantages achieved by the prior art are maintained intact.

An aspect of the present disclosure provides a vehicle heating, ventilation, and air conditioning (HVAC) system and a method for controlling the same. The HVAC system is configured to adjust the opening degree of a heating-side expansion valve according to a uniform discharge temperature mode and a heating boost mode when the HVAC system operates in a heating mode. As a result, the system appropriately deals with a conflict between cabin heating performance and temperature difference.

According to an aspect of the present disclosure, a vehicle HVAC system is provided. The system may include: a compressor; an interior condenser located on the downstream side of the compressor and disposed in an HVAC case; a heating-side expansion valve located on the downstream side of the interior condenser; a water-cooled heat exchanger located on the downstream side of the heating-side expansion valve; and a controller. The controller is configured to adjust an opening degree of the heating-side expansion valve based on a temperature difference between air flowing from the interior condenser to the front seats of a vehicle cabin and air flowing from the interior condenser to rear seats of the cabin. Additionally, the controller is configured to adjust an opening degree of the heating-side expansion valve based on an amount of heat (heat release amount) transferred from the interior condenser to the air.

The controller may be configured to determine a first opening degree of the heating-side expansion valve according to a uniform discharge temperature mode which is based on the temperature difference or may be configured to determine a second opening degree of the heating-side expansion valve according to a heating boost mode which is based on an amount of heat that is released.

The controller may be configured to determine a minimum opening degree of the heating-side expansion valve based on the revolutions per minute (RPM) of the compressor and an outdoor air temperature. The controller may be configured to determine a target opening degree of the heating-side expansion valve based on the RPM of the compressor, the outdoor air temperature, and a discharge pressure of the compressor.

The controller may be configured to determine an acceptable temperature difference based on a temperature decrease rate of the air flowing from the interior condenser to the rear seats of the cabin.

The controller may be configured to calculate the temperature decrease rate based on a discharge mode in which the air is discharged through an outlet of the HVAC case, a flow rate of the air directed toward the rear seats of the cabin, and the outdoor air temperature.

The controller may be configured to calculate the acceptable temperature difference by subtracting the temperature decrease rate from a reference temperature difference.

The controller may be configured to determine a lower limit opening degree of the heating-side expansion valve based on the acceptable temperature difference, the temperature and flow rate of a refrigerant flowing into the interior condenser, and the temperature and flow rate of the air passing by an exterior surface of the interior condenser.

The controller may be configured to determine a first opening degree of the heating-side expansion valve by selecting the highest opening degree among the minimum opening degree, the target opening degree, and the lower limit opening degree.

The controller may be configured to determine a second opening degree of the heating-side expansion valve by selecting the target opening degree.

According to an aspect of the present disclosure, a method for controlling a vehicle HVAC system including a compressor, an interior condenser located on the downstream side of the compressor and disposed in an HVAC case, a heating-side expansion valve located on the downstream side of the interior condenser, and a water-cooled heat exchanger located on the downstream side of the heating-side expansion valve. The method may include determining, by a controller, an opening degree of the heating-side expansion valve based on a temperature difference between air flowing from the interior condenser to front seats of a vehicle cabin and air flowing from the interior condenser to rear seats of the cabin, and an amount of heat (heat release amount) transferred from the interior condenser to the air.

Determining the opening degree of the heating-side expansion valve may include determining, by the controller, a first opening degree of the heating-side expansion valve according to a uniform discharge temperature mode which is based on the temperature difference, or may include determining, by the controller, a second opening degree of the heating-side expansion valve according to a heating boost mode which is based on the heat release amount.

Determining the opening degree of the heating-side expansion valve may include determining, by the controller, a minimum opening degree of the heating-side expansion valve based on the RPM of the compressor and an outdoor air temperature. Additionally, determining the opening degree of the heating-side expansion valve may include determining, by the controller, a target opening degree of the heating-side expansion valve based on the RPM of the compressor, the outdoor air temperature, and a discharge pressure of the compressor.

Determining the opening degree of the heating-side expansion valve may include determining, by the controller, an acceptable temperature difference based on a temperature decrease rate of the air flowing from the interior condenser to the rear seats of the cabin.

Determining the acceptable temperature difference may include calculating, by the controller, the temperature decrease rate based on a discharge mode in which the air is discharged through an outlet of the HVAC case, a flow rate of the air directed toward the rear seats of the cabin, and the outdoor air temperature.

Determining the acceptable temperature difference may include calculating, by the controller, the acceptable temperature difference by subtracting the temperature decrease rate from a reference temperature difference.

Determining the opening degree of the heating-side expansion valve may include determining, by the controller, a lower limit opening degree of the heating-side expansion valve based on the acceptable temperature difference, the temperature and flow rate of a refrigerant flowing into the interior condenser, and the temperature and flow rate of the air passing by an exterior surface of the interior condenser.

Determining the opening degree of the heating-side expansion valve may include determining, by the controller, a first opening degree of the heating-side expansion valve by selecting the highest opening degree among the minimum opening degree, the target opening degree, and the lower limit opening degree.

Determining the opening degree of the heating-side expansion valve may include determining, by the controller, a second opening degree of the heating-side expansion valve by selecting the target opening degree.

### BRIEF DESCRIPTION OF THE DRAWINGS

The above and other objects, features, and advantages of the present disclosure should be more apparent from the following detailed description taken in conjunction with the accompanying drawings:

FIG. 1 illustrates a configuration of a vehicle heating, ventilation, and air conditioning (HVAC) system according to an embodiment of the present disclosure;

FIG. 2 illustrates a graph of a relationship between the opening degree of a heating-side expansion valve, a heat release amount, and a temperature of air directed toward rear seats when a vehicle HVAC system according to an embodiment of the present disclosure operates in a heating mode; and

FIG. 3 illustrates a flowchart of a method for controlling a vehicle HVAC system according to an embodiment of the present disclosure.

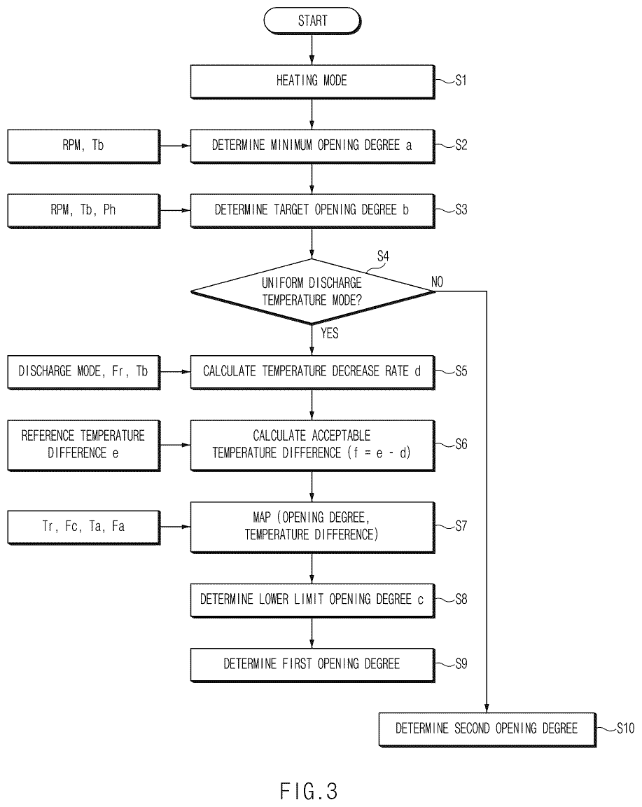

### DETAILED DESCRIPTION

Hereinafter, embodiments of the present disclosure are described in detail with reference to the accompanying drawings. In the drawings, the same reference numerals are used throughout to designate the same or equivalent elements. In addition, a detailed description of well-known techniques associated with the present disclosure has been omitted in order not to unnecessarily obscure the gist of the present disclosure.

Terms such as first, second, A, B, (a), and (b) may be used to describe the elements in embodiments of the present disclosure. These terms are only used to distinguish one element from another element, and the intrinsic features, sequence, or order, and the like of the corresponding elements are not limited by the terms. Unless otherwise defined, all terms used herein, including technical or scientific terms, have the same meanings as those generally understood by those having ordinary skill in the field to which the present disclosure belongs. Such terms as those defined in a generally used dictionary are to be interpreted as having meanings consistent with the contextual meanings in the relevant field. Such terms are not to be interpreted as having ideal or excessively formal meanings unless clearly defined as having such in the present application.

When a controller, component, device, element, part, unit, module, or the like of the present disclosure is described as having a purpose or performing an operation, function, or the like, the controller, component, device, element, part, unit, or module should be considered herein as being “configured to” meet that purpose or perform that operation or function. Each controller, component, device, element, part, unit, module, and the like may separately embody or be included with a processor and a memory, such as a non-transitory computer-readable media, as part of the apparatus.

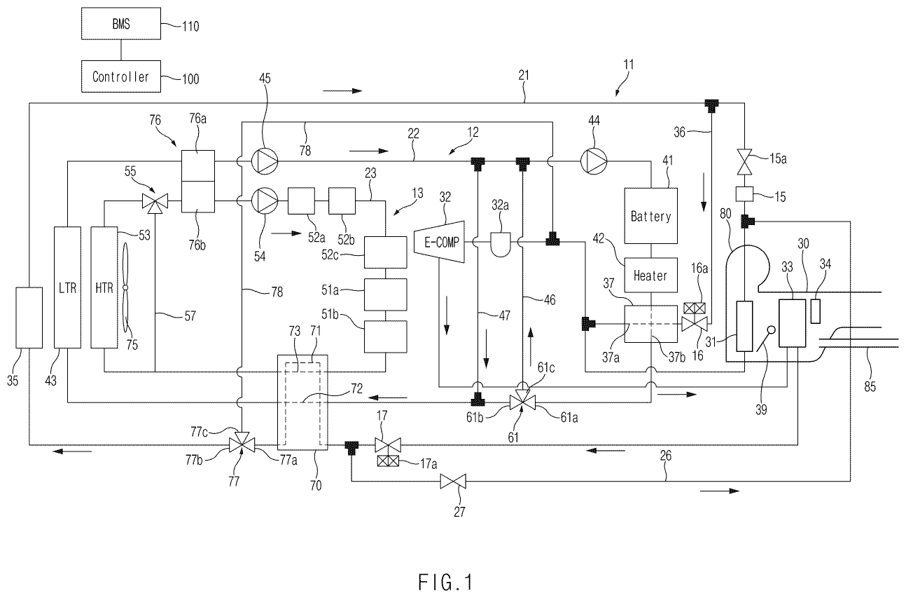

Referring to FIG. 1, a vehicle thermal management system according to an embodiment of the present disclosure may include a heating, ventilation, and air conditioning (HVAC) system 11 designed to heat or cool air in a cabin (or passenger compartment) of the vehicle. The system may also include a battery cooling system 12 configured to cool a battery 41 and may include a power electronics (PE) cooling system 13 configured to cool a plurality of PE components 51a, 51b, 52a, 52b, and 52c.

The vehicle thermal management system according to an embodiment of the present disclosure may include a water-cooled heat exchanger 70 configured to transfer heat between a refrigerant circulation path 21 of the HVAC system 11, a battery coolant circulation path 22 of the battery cooling system 12, and a PE coolant circulation path 23 of the PE cooling system 13.

The HVAC system 11 may include the refrigerant circulation path 21 through which a refrigerant circulates. The refrigerant circulation path 21 may be fluidly connected to an evaporator 31, a compressor 32, an interior condenser 33, a heating-side expansion valve 17, the water-cooled heat exchanger 70, an exterior heat exchanger 35, and a cooling-side expansion valve 15.

The evaporator 31 may be configured to cool the air using the refrigerant cooled by the exterior heat exchanger 35.

The compressor 32 may be configured to compress the refrigerant received from the evaporator 31 and/or a battery chiller 37. According to an embodiment, the compressor 32 may be an electric compressor driven by electric energy.

The interior condenser 33 may be configured to condense the refrigerant received from the compressor 32. The refrigerant passing through an internal passage of the interior condenser 33 may heat the air passing by an exterior surface of the interior condenser 33. The air passing by the exterior surface of the interior condenser 33 may be directed to front and rear seats (not illustrated) of the cabin of the vehicle (not illustrated) so that the heating of the front seats and the heating of the rear seats may be performed.

The water-cooled heat exchanger 70 may be configured to return waste heat of the PE components 51a, 51b, 52a, 52b, and 52c of the PE cooling system 13 to the HVAC system 11 and/or to the battery cooling system 12 during a heating operation of the HVAC system 11. Specifically, the water-cooled heat exchanger 70 may include a first passage 71 fluidly connected to the refrigerant circulation path 21, a second passage 72 fluidly connected to the battery coolant circulation path 22, and a third passage 73 fluidly connected to the PE coolant circulation path 23.

The water-cooled heat exchanger 70 may be configured to transfer heat between the refrigerant circulation path 21 of the HVAC system 11, the battery coolant circulation path 22 of the battery cooling system 12, and the PE coolant circulation path 23 of the PE cooling system 13. Accordingly, the refrigerant circulating in the refrigerant circulation path 21 may pass through the first passage 71 of the water-cooled heat exchanger 70. A battery coolant circulating in the battery coolant circulation path 22 of the battery cooling system 12 may pass through the second passage 72 of the water-cooled heat exchanger 70. Additionally, a PE coolant circulating in the PE coolant circulation path 23 of the PE cooling system 13 may pass through the third passage 73 of the water-cooled heat exchanger 70. As a result, heat may be transferred between the refrigerant passing through the first passage 71, the battery coolant passing through the second passage 72, and/or the PE coolant passing through the third passage 73. Specifically, the first passage 71 of the water-cooled heat exchanger 70 may be disposed between the interior condenser 33 and the exterior heat exchanger 35 in the refrigerant circulation path 21.

The water-cooled heat exchanger 70 may be configured to evaporate the refrigerant expanded by the heating-side expansion valve 17 using the heat received from the battery cooling system 12 and the PE cooling system 13 during the heating operation of the HVAC system 11. In other words, during the heating operation of the HVAC system 11, the water-cooled heat exchanger 70 may serve as an evaporator that evaporates the refrigerant by recovering the waste heat generated from the battery cooling system 12 and the PE components 51a, 51b, 52a, 52b, and 52c of the PE cooling system 13.

The water-cooled heat exchanger 70 may be configured to condense the refrigerant received from the interior condenser 33 during the heating operation of the HVAC system 11. The water-cooled heat exchanger 70 may serve as a condenser that condenses the refrigerant by cooling the refrigerant using the battery coolant circulating in the battery coolant circulation path 22 and the PE coolant circulating in the PE coolant circulation path 23.

The HVAC system 11 may further include a heating bypass line 78 configured to allow the refrigerant discharged from the first passage 71 of the water-cooled heat exchanger 70 to be directed to the compressor 32. The heating bypass line 78 may be configured to connect a downstream point of the first passage 71 of the water-cooled heat exchanger 70 and an upstream point of the compressor 32. An inlet of the heating bypass line 78 may be fluidly connected to the refrigerant circulation path 21 at the downstream point of the first passage 71 of the water-cooled heat exchanger 70. Specifically, the inlet of the heating bypass line 78 may be fluidly connected to the refrigerant circulation path 21 at a point between an outlet of the first passage 71 of the water-cooled heat exchanger 70 and an inlet of the exterior heat exchanger 35. An outlet of the heating bypass line 78 may be fluidly connected to the refrigerant circulation path 21 at the upstream point of the compressor 32. Specifically, the outlet of the heating bypass line 78 may be fluidly connected to the refrigerant circulation path 21 at a point between an outlet of the evaporator 31 and an inlet of the compressor 32. In addition, the outlet of the heating bypass line 78 may be fluidly connected to the refrigerant circulation path 21 at an accumulator 32a or an upstream point of the accumulator 32a.

The heating bypass line 78 may allow the refrigerant evaporated by the water-cooled heat exchanger 70 to flow directly into the inlet of the compressor 32 during the heating operation of the HVAC system 11.

The HVAC system 11 may further include a three-way valve 77 configured to control the flow of the refrigerant in a manner that the refrigerant discharged from the first passage 71 of the water-cooled heat exchanger 70 is selectively directed to the exterior heat exchanger 35 and/or the heating bypass line 78.

The three-way valve 77 may be disposed at a point of connection between the inlet of the heating bypass line 78 and the refrigerant circulation path 21. The three-way valve 77 may include a first port 77a communicating with the first passage 71 of the water-cooled heat exchanger 70, a second port 77b communicating with the exterior heat exchanger 35, and a third port 77c communicating with the inlet of the heating bypass line 78. The three-way valve 77 may perform a switching operation that allows the first port 77a to selectively communicate with any one of the second port 77b and the third port 77c. For example, when the three-way valve 77 is switched to allow the third port 77c to communicate with the first port 77a (i.e., the three-way valve 77 opens the inlet of the heating bypass line 78), the refrigerant discharged from the first passage 71 of the water-cooled heat exchanger 70 may be directed to the compressor 32 through the heating bypass line 78. In other words, when the inlet of the heating bypass line 78 is opened by the switching of the three-way valve 77, the refrigerant may bypass the exterior heat exchanger 35. When the three-way valve 77 is switched to allow the second port 77b to communicate with the first port 77a (i.e., the three-way valve 77 closes the inlet of the heating bypass line 78), the refrigerant discharged from the first passage 71 of the water-cooled heat exchanger 70 may not pass through the heating bypass line 78, and may instead be directed to the exterior heat exchanger 35.

The heating-side expansion valve 17 may be disposed on the upstream side of the first passage 71 of the water-cooled heat exchanger 70 in the refrigerant circulation path 21. Specifically, the heating-side expansion valve 17 may be disposed between the interior condenser 33 and the water-cooled heat exchanger 70. The heating-side expansion valve 17 may adjust the flow of the refrigerant and/or the flow rate of the refrigerant into the first passage 71 of the water-cooled heat exchanger 70 during the heating operation of the HVAC system 11. Additionally, the heating-side expansion valve 17 may be configured to expand the refrigerant received from the interior condenser 33 during the heating operation of the HVAC system 11.

The heating-side expansion valve 17 may be a full open type electronic expansion valve (EXV). Accordingly, the heating-side expansion valve 17 may be fully opened during a cooling operation of the HVAC system 11 (i.e., the opening degree of the heating-side expansion valve 17 may be 100%). During the cooling operation of the HVAC system 11, the refrigerant may not be expanded when passing through the heating-side expansion valve 17.

According to an embodiment, the heating-side expansion valve 17 may be an EXV having a drive motor 17a. The drive motor 17a may have a shaft which is movable to open or close an orifice defined in a valve body of the heating-side expansion valve 17. The position of the shaft may be varied depending on the rotation direction, rotation degree, and the like of the drive motor 17a. Accordingly, the opening degree of the orifice of the heating-side expansion valve 17 may be varied. A controller 100 may control the operation of the drive motor 17a. The opening degree of the heating-side expansion valve 17 may be varied under control of the controller 100. As the opening degree of the heating-side expansion valve 17 is varied, the flow rate of the refrigerant into the first passage 71 of the water-cooled heat exchanger 70 may be varied. The heating-side expansion valve 17 may be controlled by the controller 100 during the heating operation of the HVAC system 11.

The exterior heat exchanger 35 may be adjacent to a front grille of the vehicle (not illustrated). The exterior heat exchanger 35 may be configured to condense the refrigerant received from the interior condenser 33. In particular, the exterior heat exchanger 35 may be configured to cool the refrigerant using outdoor air forcibly blown by a cooling fan 75 so that the refrigerant may be condensed.

The exterior heat exchanger 35 may be adjacent to the front grille of the vehicle. The exterior heat exchanger 35 may be exposed to the outdoor air so that heat may be transferred between the exterior heat exchanger 35 and the outdoor air. An active air flap (not shown) may be provided to open or close the front grille of the vehicle. In particular, the exterior heat exchanger 35 may exchange heat with the outdoor air forcibly blown by the cooling fan 75 so that a heat transfer rate between the exterior heat exchanger 35 and the outdoor air may be further increased. During the cooling operation of the HVAC system 11, the exterior heat exchanger 35 may be configured to condense the refrigerant received from the interior condenser 33. In other words, the exterior heat exchanger 35 may serve as a condenser that condenses the refrigerant by transferring heat to the outdoor air during the cooling operation of the HVAC system 11. During the heating operation of the HVAC system 11, the exterior heat exchanger 35 may be configured to evaporate the refrigerant received from the first passage 71 of the water-cooled heat exchanger 70 using the outdoor air. In other words, the exterior heat exchanger 35 may serve as an evaporator that evaporates the refrigerant by absorbing heat from the outdoor air during the heating operation of the HVAC system 11.

The cooling-side expansion valve 15 may be disposed between the exterior heat exchanger 35 and the evaporator 31 in the refrigerant circulation path 21. The cooling-side expansion valve 15 may be disposed on the upstream side of the evaporator 31 so that it may adjust the flow of the refrigerant and/or the flow rate of the refrigerant into the evaporator 31. Additionally, the cooling-side expansion valve 15 may be configured to expand the refrigerant received from the exterior heat exchanger 35. The cooling-side expansion valve 15 may be a thermal expansion valve (TXV) which senses the temperature and/or pressure of the refrigerant and adjusts the opening degree of the cooling-side expansion valve 15.

According to an embodiment of the present disclosure, the cooling-side expansion valve 15 may be a TXV having a shut-off valve 15a selectively blocking or unblocking the flow of the refrigerant into an internal passage of the cooling-side expansion valve 15. The shut-off valve 15a may be a solenoid valve. As the controller 100 controls the shut-off valve 15a, the shut-off valve 15a may be opened or closed so that the shut-off valve 15a may unblock or block the flow of the refrigerant into the cooling-side expansion valve 15. When the shut-off valve 15a is opened, the refrigerant may be allowed to flow into the cooling-side expansion valve 15. When the shut-off valve 15a is closed, the refrigerant may be blocked from flowing into the cooling-side expansion valve 15. According to an embodiment, the shut-off valve 15a may be mounted in a valve body of the cooling-side expansion valve 15, thereby opening or closing the internal passage of the cooling-side expansion valve 15. According to another embodiment, the shut-off valve 15a may be disposed on the upstream side of the cooling-side expansion valve 15, thereby selectively opening or closing an inlet of the cooling-side expansion valve 15.

When the shut-off valve 15a is closed, the cooling-side expansion valve 15 may be blocked. Accordingly, the refrigerant may not be directed to the cooling-side expansion valve 15 and the evaporator 31 but may only be directed to the battery chiller 37. In other words, when the shut-off valve 15a is closed, the cooling operation of the HVAC system 11 may not be performed. When the shut-off valve 15a is opened, the refrigerant may be directed to the cooling-side expansion valve 15 and the evaporator 31. In other words, when the shut-off valve 15a of the cooling-side expansion valve 15 is opened, the cooling operation of the HVAC system 11 may be performed.

The HVAC system 11 may include an HVAC case 30 configured to blow the air into the cabin of the vehicle. The HVAC case 30 may have an inlet through which the air flows in, and an outlet through which the air is discharged to the cabin.

The evaporator 31, the interior condenser 33, and an electric heater 34 may be located in the HVAC case 30. The evaporator 31, the interior condenser 33, and the electric heater 34 may be arranged sequentially from upstream to downstream in an air flow direction within the HVAC case 30. An air mixing door 39 may be disposed between the evaporator 31 and the interior condenser 33. The electric heater 34 may be disposed on the downstream side of the interior condenser 33 in the air flow direction. The electric heater 34 may be a positive temperature coefficient (PTC) heater. The electric heater 34 may operate to help in heating the cabin, thereby relatively increasing the temperature of the air blown into the cabin.

The HVAC system 11 may further include the accumulator 32a disposed between the evaporator 31 and the compressor 32 in the refrigerant circulation path 21. The accumulator 32a may be located on the downstream side of the evaporator 31. The accumulator 32a may separate a liquid refrigerant from the refrigerant received from the evaporator 31, thereby preventing the liquid refrigerant from flowing into the compressor 32.

The HVAC system 11 may further include a branch line 36 allowing the refrigerant discharged from the exterior heat exchanger 35 to be directed to the compressor 32. An inlet of the branch line 36 may be fluidly connected to the refrigerant circulation path 21 at an upstream point of the cooling-side expansion valve 15. Specifically, the inlet of the branch line 36 may be fluidly connected to the refrigerant circulation path 21 at a point between the exterior heat exchanger 35 and the cooling-side expansion valve 15. An outlet of the branch line 36 may be fluidly connected to the refrigerant circulation path 21 at an upstream point of the compressor 32. Specifically, the outlet of the branch line 36 may be fluidly connected to the refrigerant circulation path 21 at a point between the outlet of the evaporator 31 and the inlet of the compressor 32. In addition, the outlet of the branch line 36 may be fluidly connected to the refrigerant circulation path 21 at an upstream point of the accumulator 32a.

The HVAC system 11 may include the battery chiller 37 fluidly connected to the branch line 36. The battery chiller 37 and the evaporator 31 may be fluidly connected in parallel to the compressor 32. The battery chiller 37 may be thermally connected to the battery cooling system 12. The battery chiller 37 may be configured to transfer heat between the refrigerant passing through the branch line 36 and the coolant passing through the battery coolant circulation path 22. The battery chiller 37 may include a first passage 37a fluidly connected to the branch line 36 and may include a second passage 37b fluidly connected to the battery coolant circulation path 22. The first passage 37a and the second passage 37b may be adjacent to each other or contact each other in the battery chiller 37, and the first passage 37a may be fluidly separated from the second passage 37b. Accordingly, the battery chiller 37 may be configured to transfer heat between the coolant passing through the second passage 37b and the refrigerant passing through the first passage 37a.

A chiller-side expansion valve 16 may be disposed on the upstream side of the battery chiller 37 in the branch line 36. The chiller-side expansion valve 16 may adjust the flow of the refrigerant and/or the flow rate of the refrigerant into the battery chiller 37. The chiller-side expansion valve 16 may be configured to expand the refrigerant received from the exterior heat exchanger 35.

According to an embodiment, the chiller-side expansion valve 16 may be an EXV having a drive motor 16a. The drive motor 16a may have a shaft that is movable to open or close an internal passage defined in a valve body of the chiller-side expansion valve 16. The position of the shaft may be varied depending on the rotation direction, rotation degree, and the like of the drive motor 16a. Accordingly, the opening degree of the internal passage of the chiller-side expansion valve 16 may be varied. The controller 100 may control the operation of the drive motor 16a.

As the opening degree of the chiller-side expansion valve 16 is varied, the flow rate of the refrigerant into the battery chiller 37 may be varied. For example, when the opening degree of the chiller-side expansion valve 16 is greater than a reference opening degree, the flow rate of the refrigerant into the battery chiller 37 may be relatively increased above a reference flow rate. When the opening degree of the chiller-side expansion valve 16 is less than the reference opening degree, the flow rate of the refrigerant into the battery chiller 37 may be similar to the reference flow rate or be relatively lowered below the reference flow rate. The reference opening degree refers to an opening degree of the chiller-side expansion valve 16 required for maintaining a target evaporator temperature. The reference flow rate refers to a flow rate of the refrigerant into the battery chiller 37 when the chiller-side expansion valve 16 is opened to the reference opening degree. Accordingly, when the chiller-side expansion valve 16 is opened to the reference opening degree, the refrigerant may flow into the battery chiller 37 at the corresponding reference flow rate.

As the opening degree of the cooling-side expansion valve 15 and the opening degree of the chiller-side expansion valve 16 are adjusted by the controller 100, the refrigerant may be distributed to the evaporator 31 and the battery chiller 37 at a predetermined ratio. Accordingly, the cooling of the HVAC system 11 and the cooling of the battery chiller 37 may be performed simultaneously or selectively. The controller 100 may be configured to control respective operations of the cooling-side expansion valve 15, the chiller-side expansion valve 16, the compressor 32, and the like of the HVAC system 11. As a result, the overall operation of the HVAC system 11 may be controlled by the controller 100.

The HVAC system 11 may further include a dehumidification bypass line 26 configured to allow at least a portion of the refrigerant discharged from the heating-side expansion valve 17 to be directed to the evaporator 31. An inlet of the dehumidification bypass line 26 may be fluidly connected to the refrigerant circulation path 21 at a point between the heating-side expansion valve 17 and the first passage 71 of the water-cooled heat exchanger 70. An outlet of the dehumidification bypass line 26 may be fluidly connected to the refrigerant circulation path 21 at an upstream point of the evaporator 31. A shut-off valve 27 may be provided to open or close the dehumidification bypass line 26. When dehumidification in the cabin is required during the heating operation of the HVAC system 11, the shut-off valve 27 may be opened so that at least a portion of the refrigerant flowing from the heating-side expansion valve 17 to the first passage 71 of the water-cooled heat exchanger 70 may be directed to the evaporator 31 through the dehumidification bypass line 26. Accordingly, the refrigerant directed to the evaporator 31 may absorb heat from the air passing by an exterior surface of the evaporator 31. Thus, the heating and dehumidification of the cabin may be performed simultaneously.

The battery cooling system 12 may include the battery coolant circulation path 22 through which the battery coolant circulates. The battery coolant circulation path 22 may be fluidly connected to the battery 41, a battery heater 42, the battery chiller 37, the second passage 72 of the water-cooled heat exchanger 70, a battery radiator 43, a battery reservoir 76a, a second battery pump 45, and a first battery pump 44. In FIG. 1, the coolant may sequentially pass through the battery 41, the battery heater 42, the battery chiller 37, the second passage 72 of the water-cooled heat exchanger 70, the battery radiator 43, the battery reservoir 76a, the second battery pump 45, and the first battery pump 44 in the battery coolant circulation path 22.

The battery 41 may have a coolant passage provided inside or outside thereof, and the battery coolant may pass through the coolant passage. The battery coolant circulation path 22 may be fluidly connected to the coolant passage of the battery 41.

The battery heater 42 may be disposed between the battery chiller 37 and the battery 41. The battery heater 42 may have an internal passage fluidly connected to the battery coolant circulation path 22. The battery heater 42 may be configured to heat the battery coolant passing through the internal passage thereof. According to an embodiment, the battery heater 42 may be an electric heater. In order to maintain the temperature of the battery 41 at an optimal operating temperature, when the warming-up of the battery 41 is required, the battery heater 42 may operate so that the battery coolant may be heated. The heated battery coolant may pass through the coolant passage of the battery 41 so that the temperature of the battery 41 may be increased to the optimal operating temperature.

The battery radiator 43 may be adjacent to the front grille of the vehicle. The battery radiator 43 may be cooled using the outdoor air forcibly blown by the cooling fan 75. The battery radiator 43 may be adjacent to the exterior heat exchanger 35.

The first battery pump 44 may be configured to allow the coolant to circulate through the battery coolant circulation path 22. The first battery pump 44 may be located at an upstream point of the battery 41. Specifically, the first battery pump 44 may be fluidly connected to the battery coolant circulation path 22 at a point adjacent to an inlet of the battery 41.

The second battery pump 45 may be configured to allow the coolant to circulate through the battery coolant circulation path 22. The second battery pump 45 may be located at a downstream point of the battery radiator 43. Specifically, the second battery pump 45 may be fluidly connected to the battery coolant circulation path 22 at a point adjacent to an outlet of the battery radiator 43.

The battery cooling system 12 may include a battery reservoir 76a located at a downstream point of the battery radiator 43. The battery reservoir 76a may be located between the battery radiator 43 and the second battery pump 45. The battery reservoir 76a may temporarily store and replenish the battery coolant so that the flow rate of the battery coolant circulating in the battery coolant circulation path 22 may be constantly maintained.

The battery cooling system 12 may further include a first battery bypass line 46 allowing the battery coolant to bypass the battery radiator 43. The first battery bypass line 46 may be configured to directly connect a downstream point of the battery radiator 43 and an upstream point of the battery radiator 43 in the battery coolant circulation path 22.

An inlet of the first battery bypass line 46 may be fluidly connected to the battery coolant circulation path 22 at a point between the second passage 37b of the battery chiller 37 and the battery radiator 43. Specifically, the inlet of the first battery bypass line 46 may be fluidly connected to the battery coolant circulation path 22 at a point between the second passage 37b of the battery chiller 37 and the second passage 72 of the water-cooled heat exchanger 70.

An outlet of the first battery bypass line 46 may be fluidly connected to the battery coolant circulation path 22 at a point between the battery 41 and the battery radiator 43. Specifically, the outlet of the first battery bypass line 46 may be fluidly connected to the battery coolant circulation path 22 at a point between an inlet of the first battery pump 44 and an outlet of the battery reservoir 76a.

As the battery coolant flows from the downstream side of the battery chiller 37 to the upstream side of the first battery pump 44 through the first battery bypass line 46, the battery coolant may be allowed to bypass the second battery pump 45, the battery radiator 43, the battery reservoir 76a, and the second passage 72 of the water-cooled heat exchanger 70. Accordingly, the battery coolant passing through the first battery bypass line 46 may sequentially pass through the battery 41, the battery heater 42, and the battery chiller 37 by the first battery pump 44.

The battery cooling system 12 may further include a second battery bypass line 47 allowing the battery coolant to bypass the first battery pump 44, the battery 41, the battery heater 42, and the battery chiller 37. The second battery bypass line 47 may be configured to directly connect a downstream point of the battery chiller 37 and an upstream point of the battery 41 in the battery coolant circulation path 22.

An inlet of the second battery bypass line 47 may be fluidly connected to the battery coolant circulation path 22 at a point between the outlet of the first battery bypass line 46 and the outlet of the battery radiator 43. Specifically, the inlet of the second battery bypass line 47 may be fluidly connected to the battery coolant circulation path 22 at a point between the outlet of the first battery bypass line 46 and an outlet of the second battery pump 45.

An outlet of the second battery bypass line 47 may be fluidly connected to the battery coolant circulation path 22 at a point between the inlet of the first battery bypass line 46 and an inlet of the battery radiator 43. Specifically, the outlet of the second battery bypass line 47 may be fluidly connected to the battery coolant circulation path 22 at a point between the inlet of the first battery bypass line 46 and an inlet of the second passage 72 of the water-cooled heat exchanger 70.

As the battery coolant is directed to the battery radiator 43 through the second battery bypass line 47 by the second battery pump 45, the battery coolant may be allowed to bypass the battery 41, the battery heater 42, and the battery chiller 37. Accordingly, the battery coolant passing through the second battery bypass line 47 may sequentially pass through the second passage 72 of the water-cooled heat exchanger 70, the battery radiator 43, and the battery reservoir 76a by the second battery pump 45.

The first battery bypass line 46 and the second battery bypass line 47 may be parallel to each other.

The battery cooling system 12 may further include a three-way valve 61 disposed at the inlet of the first battery bypass line 46. In other words, the three-way valve 61 may be disposed at a junction between the inlet of the first battery bypass line 46 and the battery coolant circulation path 22. The three-way valve 61 may include a first port 61a fluidly connected to the battery chiller 37, a second port 61b fluidly connected to the second passage 72 of the water-cooled heat exchanger 70, and a third port 61c fluidly connected to the first battery bypass line 46. The three-way valve 61 may perform a switching operation which allows at least two of the first port 61a, the second port 61b, and the third port 61c to selectively communicate with each other. The first battery pump 44 and the second battery pump 45 may selectively operate based on the switching operation of the three-way valve 61.

When the three-way valve 61 is switched to allow the second port 61b to communicate with the first port 61a (i.e., the three-way valve 61 is switched to close the inlet of the first battery bypass line 46), the battery coolant may not pass through the first battery bypass line 46 and the second battery bypass line 47. Instead, the battery coolant may sequentially pass through the battery 41, the battery heater 42, the battery chiller 37, the second passage 72 of the water-cooled heat exchanger 70, and the battery radiator 43.

When the three-way valve 61 is switched to allow the third port 61c to communicate with the first port 61a (i.e., the three-way valve 61 is switched to open the inlet of the first battery bypass line 46), a portion of the battery coolant may pass through the first battery bypass line 46 so that it may bypass the second battery pump 45, the second passage 72 of the water-cooled heat exchanger 70, and the battery radiator 43. Instead, the portion of the battery coolant may sequentially pass through the battery 41, the battery heater 42, and the battery chiller 37 by the first battery pump 44. A remaining portion of the battery coolant may pass through the second battery bypass line 47 so that it may bypass the first battery pump 44, the battery 41, the battery heater 42, and the battery chiller 37. The remaining portion of the battery coolant may sequentially pass through the second passage 72 of the water-cooled heat exchanger 70 and the battery radiator 43 by the second battery pump 45.

As described above, the three-way valve 61 may be configured to adjust the flow of the battery coolant in the battery coolant circulation path 22. The first battery pump 44 and the second battery pump 45 may selectively operate based on the switching operation of the three-way valve 61.

The battery cooling system 12 may be controlled by a battery management system 110 and the controller 100. The battery management system 110 may monitor the state of the battery 41, and perform the cooling of the battery 41 when the temperature of the battery 41 is higher than or equal to a threshold temperature. The battery management system 110 may transmit an instruction for the cooling of the battery 41 to the controller 100. Accordingly, the controller 100 may allow the compressor 32 to operate and allow the chiller-side expansion valve 16 to open. When the operation of the HVAC system 11 is not required during the cooling operation of the battery 41, the controller 100 may allow the cooling-side expansion valve 15 to close. In addition, the battery management system 110 may control the operation of the first battery pump 44 and the switching operation of the three-way valve 61 so that the battery coolant may be allowed to bypass the battery radiator 43 and pass through the battery 41 and the battery chiller 37 as necessary.

The PE cooling system 13 may be configured to cool the plurality of PE components 51a, 51b, 52a, 52b, and 52c using the PE coolant circulating in the PE coolant circulation path 23.

The PE cooling system 13 may include the PE coolant circulation path 23 through which the PE coolant circulates. The PE coolant circulation path 23 may be fluidly connected to the plurality of PE components 51a, 51b, 52a, 52b, and 52c, a PE radiator 53, a PE pump 54, and a PE reservoir 76b.

According to an embodiment, the plurality of PE components may include a front-wheel-side electric motor 51a driving front wheels, and a rear-wheel-side electric motor 51b driving rear wheels. The plurality of PE components may also include a front-wheel-side inverter 52a controlling the speed and direction of the front-wheel-side electric motor 51a, an integrated charging control unit (ICCU) 52b charging a high-voltage battery and a secondary battery of an electric vehicle, and a rear-wheel-side inverter 52c controlling the speed and direction of the rear-wheel-side electric motor 51b.

Each of the PE components 51a, 51b, 52a, 52b, and 52c may have a coolant passage provided inside or outside thereof. The coolant may pass through the coolant passage. The PE coolant circulation path 23 may be fluidly connected to the coolant passage of each of the PE components 51a, 51b, 52a, 52b, and 52c.

The PE radiator 53 may be adjacent to the front grille of the vehicle. The PE radiator 53 may be cooled using the outdoor air forcibly blown by the cooling fan 75. The exterior heat exchanger 35, the battery radiator 43, and the PE radiator 53 may be disposed adjacent to each other on the front of the vehicle. The cooling fan 75 may be disposed behind the exterior heat exchanger 35, the battery radiator 43, and the PE radiator 53.

The PE pump 54 may be disposed on the upstream side of the PE components 51a, 51b, 52a, 52b, and 52c, and the PE pump 54 may allow the coolant to circulate in the PE coolant circulation path 23. The operation of the PE pump 54 may be controlled by the controller 100.

The PE reservoir 76b may be disposed on the downstream side of the PE radiator 53. In particular, the PE reservoir 76b may be disposed between the PE radiator 53 and the PE pump 54 in the PE coolant circulation path 23.

The PE cooling system 13 may further include a PE bypass line 57 allowing the PE coolant discharged from the third passage 73 of the water-cooled heat exchanger 70 to bypass the PE radiator 53 and be directed to the PE components 52a, 52b, 52c, 51a, and 51b. The PE bypass line 57 may be configured to directly connect an upstream point of the PE radiator 53 and a downstream point of the PE radiator 53 in the PE coolant circulation path 23. An inlet of the PE bypass line 57 may be fluidly connected to the PE coolant circulation path 23 at a point between the third passage 73 of the water-cooled heat exchanger 70 and an inlet of the PE radiator 53. An outlet of the PE bypass line 57 may be fluidly connected to the PE coolant circulation path 23 at a point between an outlet of the PE radiator 53 and the PE reservoir 76b.

The PE cooling system 13 may include a three-way valve 55 disposed at the outlet of the PE bypass line 57. The three-way valve 55 may be disposed at a junction between the outlet of the PE bypass line 57 and the PE coolant circulation path 23. When the three-way valve 55 is switched to close the outlet of the PE bypass line 57, the PE coolant may not pass through the PE bypass line 57. Instead, the PE coolant may sequentially pass through the PE components 52a, 52b, 52c, 51a, and 51b, the third passage 73 of the water-cooled heat exchanger 70, the PE radiator 53, and the PE reservoir 76b. When the three-way valve 55 is switched to open the outlet of the PE bypass line 57, the PE coolant may pass through the PE bypass line 57 so that it may bypass the PE radiator 53. As a result, the PE coolant may sequentially pass through the PE components 52a, 52b, 52c, 51a, and 51b, the third passage 73 of the water-cooled heat exchanger 70, and the PE reservoir 76b. The three-way valve 55 may adjust the flow of the PE coolant in the PE coolant circulation path 23.

According to an embodiment, the battery reservoir 76a and the PE reservoir 76b may be joined to form an integrated reservoir 76. The battery reservoir 76a and the PE reservoir 76b may be fluidly separated from each other by a partition or the like.

According to another embodiment, the battery reservoir 76a and the PE reservoir 76b may be fluidly connected to each other in the integrated reservoir 76. Accordingly, the battery coolant and the PE coolant may be mixed in the integrated reservoir 76.

The vehicle thermal management system according to an embodiment of the present disclosure may include an outdoor air temperature sensor (not illustrated) measuring the outdoor air temperature of the vehicle, a coolant temperature sensor (not illustrated) measuring the temperature of the coolant circulating in the battery coolant circulation path, a refrigerant pressure/temperature sensor (not illustrated) measuring the pressure and temperature of the low-pressure refrigerant, an evaporator temperature sensor (not illustrated) provided adjacent to the evaporator, and an interior temperature sensor (not illustrated) measuring the interior temperature of the cabin.

The outdoor air temperature sensor may be adjacent to the front grille of the vehicle so that it may measure the outdoor air temperature of the vehicle. The outdoor air temperature measured by the outdoor air temperature sensor may be used for optimal control of the HVAC system 11 and the battery cooling system 12.

The coolant temperature sensor may be provided on the battery coolant circulation path 22 and may measure the temperature of the coolant circulating in the battery coolant circulation path 22. The temperature of the coolant measured by the coolant temperature sensor may be used for optimal control of the HVAC system 11 and the battery cooling system 12. According to an embodiment, the coolant temperature sensor may be disposed on the downstream side of the battery radiator 43 in the battery coolant circulation path 22. In FIG. 1, the coolant temperature sensor may be located between the outlet of the battery radiator 43 and the inlet of the second battery pump 45.

The refrigerant pressure/temperature sensor may be located on the downstream side of the battery chiller 37 and may measure the pressure and temperature of the low-pressure refrigerant expanded by the chiller-side expansion valve 16. The pressure and temperature of the refrigerant measured by the refrigerant pressure/temperature sensor may be used for optimal control of the HVAC system 11 and the battery cooling system 12. The evaporator temperature sensor may be provided on the exterior surface of the evaporator 31 or may be adjacent to the evaporator 31. The evaporator temperature sensor may measure the temperature of the evaporator 31 and the temperature of the air passing by the exterior surface of the evaporator 31. The temperature of the evaporator 31 and the temperature of the air passing by the exterior surface of the evaporator 31 measured by the evaporator temperature sensor may be used for optimal control of the HVAC system 11 and the battery cooling system 12.

The interior temperature sensor may be provided in the cabin and may measure the interior temperature of the cabin. The interior temperature of the cabin measured by the interior temperature sensor may be used for optimal control of the HVAC system 11 and the battery cooling system 12.

The controller 100 may appropriately control the operations of the HVAC system 11, the battery cooling system 12, and the PE cooling system 13 using information received from various sensors such as the outdoor air temperature sensor, the coolant temperature sensor, the refrigerant pressure/temperature sensor, the evaporator temperature sensor, and the interior temperature sensor. For example, the controller 100 may control the operations of the shut-off valve 15a of the cooling-side expansion valve 15, the electric heater 34, the air mixing door 39, the compressor 32, the cooling fan 75, the drive motor 16a of the chiller-side expansion valve 16, the drive motor 17a of the heating-side expansion valve 17, the first battery pump 44, the second battery pump 45, the PE pump 54, the three-way valves 55, 61, and 77, and the like. As a result, the cooling and heating of the cabin, the cooling of the battery 41, and the cooling of the PE components 51a, 51b, 52a, 52b, and 52c may be appropriately performed. According to an embodiment, the controller 100 may be a fully automatic temperature control (FATC) system or a dual automatic temperature control (DATC) system.

The controller 100 may include a processor and a memory. The processor may be programmed to receive instructions stored in the memory. The processor may transmit the instructions to the HVAC system 11, the battery cooling system 12, and the PE cooling system 13. The memory may be a data store such as a hard disk drive, a solid state drive, a server, a volatile storage medium, and a non-volatile storage medium.

When the HVAC system 11 operates in a heating mode to heat the cabin, the shut-off valve 15a of the cooling-side expansion valve 15 may be closed, the opening degree of the heating-side expansion valve 17 may be adjusted, and the three-way valve 77 may be switched to allow the third port 77c to communicate with the first port 77a. The refrigerant compressed by the compressor 32 may be condensed in the interior condenser 33. The refrigerant condensed by the interior condenser 33 may be expanded in the heating-side expansion valve 17. The expanded refrigerant may be evaporated in the first passage 71 of the water-cooled heat exchanger 70 and the evaporated refrigerant may be directed to the compressor 32 through the heating bypass line 78. In other words, the refrigerant may sequentially pass through the compressor 32, the interior condenser 33, the heating-side expansion valve 17, and the water-cooled heat exchanger 70. The air passing by the exterior surface of the interior condenser 33 may be heated by the refrigerant passing through the internal passage of the interior condenser 33. The heated air may be directed toward the front seats of the cabin through the outlet of the HVAC case 30 and the rear seats of the cabin through a rear-seat duct 85 so that the heating of the front and rear seats of the cabin may be performed.

In order to avoid operational limits caused by a decrease in pressure of the refrigerant, the interior condenser 33 may be configured to allow the refrigerant to flow in one direction. Accordingly, the temperature of the air passing by the exterior surface of the interior condenser 33 may differ depending on the flow direction of the refrigerant. For example, the interior condenser 33 may have an inlet header located above an outlet header, and a plurality of tubes may be configured to connect the inlet header and the outlet header. When the refrigerant flows from the inlet header to the outlet header through the plurality of tubes, a temperature difference between the air passing by an upper portion of the interior condenser 33 and the air passing by a lower portion of the interior condenser 33 may occur. The air passing by the upper portion of the interior condenser 33 may be directed toward the front seats of the cabin through the outlet of the HVAC case 30. The air passing by the lower portion of the interior condenser 33 may be directed toward the rear seats of the cabin through the rear-seat duct 85 so that a temperature difference between the air directed toward the front seats of the cabin and the air directed toward the rear seats of the cabin may occur. Herein, the term “temperature difference” is used to mean the temperature difference between the temperature of the air flowing from the interior condenser 33 to the front seats of the cabin and the temperature of the air flowing from the interior condenser 33 to the rear seats of the cabin.

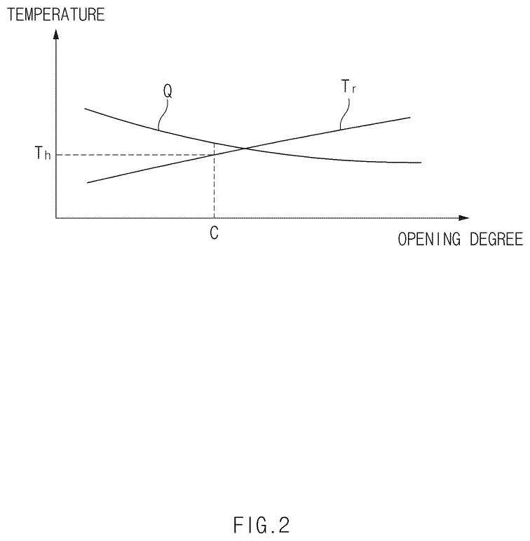

In a state in which the HVAC system 11 operates in the heating mode, when the opening degree of the heating-side expansion valve 17 increases, the flow resistance of the refrigerant may relatively decrease. Since a difference between a suction pressure (suction temperature) of the compressor 32 and a discharge pressure (discharge temperature) of the compressor 32 relatively decreases, the temperature and pressure of the refrigerant flowing into the interior condenser 33 may decrease, and the flow rate of the refrigerant into the interior condenser 33 may increase. In other words, as the opening degree of the heating-side expansion valve 17 increases, the temperature and pressure of the refrigerant flowing into the interior condenser 33 may relatively decrease. As illustrated in FIG. 2, as the opening degree of the heating-side expansion valve 17 increases, an amount Q of heat (hereinafter referred to as “heat release amount Q”) transferred from the interior condenser 33 to the air may relatively decrease, and a temperature Tᵣ of the air directed toward the rear seats of the cabin may relatively increase.

Referring to FIG. 2, as the opening degree of the heating-side expansion valve 17 increases, the heat release amount Q may relatively decrease. Accordingly, the cabin heating performance of the HVAC system 11 may be reduced. In addition, as the opening degree of the heating-side expansion valve 17 decreases, the heat release amount Q may relatively increase, and accordingly the cabin heating performance of the HVAC system 11 may be improved. In other words, the heat release amount Q and the cabin heating performance of the HVAC system 11 may be inversely proportional to the opening degree of the heating-side expansion valve 17. In addition, as the opening degree of the heating-side expansion valve 17 increases, the temperature Tᵣ of the air directed toward the rear seats may relatively increase so that the temperature difference may be reduced. As the opening degree of the heating-side expansion valve 17 decreases, the temperature Tᵣ of the air directed toward the rear seats may relatively decrease so that the temperature difference may be increased. In other words, the temperature Tᵣ of the air directed toward the rear seats of the cabin may be proportional to the opening degree of the heating-side expansion valve 17. Additionally, the temperature difference may be inversely proportional to the opening degree of the heating-side expansion valve 17.

Referring to FIG. 2, when the opening degree of the heating-side expansion valve 17 is higher than a lower limit opening degree C., the heat release amount Q (i.e., the amount of heat released) may relatively decrease, and the temperature Tᵣ of the air flowing from the interior condenser 33 to the rear seats may relatively increase so that the temperature difference may be relatively reduced. When the opening degree of the heating-side expansion valve 17 is lower than the lower limit opening degree C., the heat release amount Q may relatively increase, but the temperature Tᵣ of the air flowing from the interior condenser 33 to the rear seats may relatively decrease so that the temperature difference may be relatively increased. A lower limit Tₕ of the temperature Tᵣ of the air flowing from the interior condenser 33 to the rear seats may correspond to the lower limit opening degree C. of the heating-side expansion valve 17. Additionally, the lower limit Tₕ of the temperature Tᵣ of the air refers to a temperature corresponding to an acceptable temperature difference. In other words, the lower limit opening degree C. refers to a limit on the opening degree of the heating-side expansion valve 17 corresponding to the acceptable temperature difference. As described above, the cabin heating performance and the temperature difference may be in conflict with each other based on the lower limit opening degree C. of the heating-side expansion valve 17.

According to an embodiment of the present disclosure, when the HVAC system 11 operates in the heating mode, an occupant may select any one of a uniform discharge temperature mode and a heating boost mode. The uniform discharge temperature mode refers to a mode in which the temperature difference is minimized so that a temperature of the front seats and a temperature of the rear seats may become uniform. The heating boost mode refers to a mode in which the heat release amount transferred from the interior condenser 33 to the air and the heating performance related thereto are maximized regardless of the temperature difference. The controller 100 may adjust the opening degree of the heating-side expansion valve 17 based on the temperature difference between the air flowing from the interior condenser 33 to the front seats of the cabin and the air flowing from the interior condenser 33 to the rear seats of the cabin. Additionally, the controller 100 may adjust the opening degree of the heating-side expansion valve 17 based on the heat release amount Q transferred from the interior condenser 33 to the air.

According to an embodiment of the present disclosure, the controller 100 may be configured to determine a first opening degree of the heating-side expansion valve 17 according to the uniform discharge temperature mode which is based on the temperature difference, or may be configured to determine a second opening degree of the heating-side expansion valve 17 according to the heating boost mode which is based on the heat release amount Q. When the HVAC system 11 operates in the heating mode, the controller 100 may adjust the opening degree of the heating-side expansion valve 17 as any one of the uniform discharge temperature mode and the heating boost mode. Accordingly, the HVAC system 11 may appropriately deal with a conflict between the cabin heating performance and the temperature difference.

Referring to 3, the HVAC system 11 may operate in a heating mode (S1). The controller 100 may determine a minimum opening degree a of the heating-side expansion valve 17 based on the revolutions per minute (RPM) of the compressor 32 and an outdoor air temperature Tb (S2).

The controller 100 may determine a target opening degree b of the heating-side expansion valve 17 based on the RPM of the compressor 32, the outdoor air temperature Tb, and a discharge pressure Ph of the compressor 32 (S3). The target opening degree b may be higher than the minimum opening degree a.

The controller 100 may determine whether a uniform discharge temperature mode is selected by an occupant (S4). With occupants occupying both the front and rear seats of the cabin, the uniform discharge temperature mode may be selected to uniformly maintain the temperature of the front seats and the temperature of the rear seats.

When the controller 100 determines that the uniform discharge temperature mode is selected by the occupant, the controller 100 may calculate a temperature decrease rate d, i.e., a decrease in the temperature of air flowing from the interior condenser 33 to the rear seats of the cabin (S5). Specifically, the temperature decrease rate d refers to the rate of decrease of air temperature that decreases when the air is guided from the interior condenser 33 to the rear seats of the cabin through the rear-seat duct 85.

According to an embodiment, the controller 100 may calculate the temperature decrease rate d based on a discharge mode in which the air heated by the interior condenser 33 is discharged through the outlet of the HVAC case 30, a flow rate Fr of the air guided to the rear seats of the cabin through the rear-seat duct 85, and the outdoor air temperature Tb.

The controller 100 may calculate an acceptable temperature difference f by subtracting the temperature decrease rate d from a predetermined reference temperature difference e (f=e−d) (S6). The reference temperature difference e refers to a temperature difference that is maximally tolerated by or acceptable to the occupant. The reference temperature difference e may be predetermined depending on the specifications of the vehicle, external environmental conditions, heating settings of the HVAC system 11, and the like. The reference temperature difference e may be previously input in the memory of the controller 100. The acceptable temperature difference f may be a temperature difference acceptable on the downstream side of the interior condenser 33.

The controller 100 may apply the acceptable temperature difference f, temperature Tr and flow rate Fc of the refrigerant flowing into the interior condenser 33, and temperature Ta and flow rate Fa of the air passing by the exterior surface of the interior condenser 33 to a map (S7). The controller 100 may determine a lower limit opening degree C. of the heating-side expansion valve 17 through the map (S8). The map may be mapping data including the opening degrees of the heating-side expansion valve 17 and the corresponding temperature differences. In other words, the controller 100 may determine the lower limit opening degree C. of the heating-side expansion valve 17 based on the acceptable temperature difference f, the temperature Tr and flow rate Fc of the refrigerant flowing into the interior condenser 33, and the temperature Ta and flow rate Fa of the air passing by the exterior surface of the interior condenser 33.

The controller 100 may select the highest opening degree among the minimum opening degree a, the target opening degree b, and the lower limit opening degree C. As a result, the controller may determine a first opening degree of the heating-side expansion valve 17 in order for the HVAC system 11 to operate in the uniform discharge temperature mode (S9). The controller 100 may determine the first opening degree of the heating-side expansion valve 17, thereby minimizing the temperature difference between the air flowing from the interior condenser 33 toward the front seats and the air flowing from the interior condenser 33 toward the rear seats. As a result, the HVAC system 11 may operate in the uniform discharge temperature mode in which the temperature of the front seats and the temperature of the rear seats become uniform.

When the controller 100 determines in S4 that the uniform discharge temperature mode is not selected, a heating boost mode may be automatically selected to thereby maximize the cabin heating performance of the HVAC system 11. Accordingly, the controller 100 may open or close the outlet of the HVAC case 30 or the outlet of the rear-seat duct 85 so that the air heated by the interior condenser 33 may be allowed to be directed to the front seat or rear seats. When it is determined in S4 that the uniform discharge temperature mode is not selected, the controller 100 may select the target opening degree b to thereby determine a second opening degree of the heating-side expansion valve 17 in order for the HVAC system 11 to operate in the heating boost mode (S10).

As set forth above, according to embodiments of the present disclosure, when the HVAC system operates in the heating mode, the controller may adjust the opening degree of the heating-side expansion valve as any one of the uniform discharge temperature mode and the heating boost mode that is selected. Accordingly, the HVAC system may appropriately deal with a conflict between the cabin heating performance and the temperature difference.

Hereinabove, although the present disclosure has been described with reference to embodiments and the accompanying drawings, the present disclosure is not limited thereto. The present disclosure may be variously modified and altered by those having ordinary skill in the art to which the present disclosure pertains without departing from the spirit and scope of the present disclosure claimed in the following claims.

What is claimed is:

1. A vehicle heating, ventilation, and air conditioning (HVAC) system, the vehicle HVAC system comprising:
a compressor;
an interior condenser located on a downstream side of the compressor and disposed in an HVAC case;
a heating-side expansion valve located on a downstream side of the interior condenser;
a water-cooled heat exchanger located on a downstream side of the heating-side expansion valve; and
a controller configured to adjust an opening degree of the heating-side expansion valve based on a temperature difference between air flowing from the interior condenser to front seats of a cabin of a vehicle and air flowing from the interior condenser to rear seats of the cabin, and an amount of heat transferred from the interior condenser to the air.

2. The vehicle HVAC system according to claim 1, wherein the controller is configured to:
determine a first opening degree of the heating-side expansion valve according to a uniform discharge temperature mode which is based on the temperature difference; or
determine a second opening degree of the heating-side expansion valve according to a heating boost mode which is based on an amount of heat released.

3. The vehicle HVAC system according to claim 1, wherein:
the controller is configured to determine a minimum opening degree of the heating-side expansion valve based on revolutions per minute (RPM) of the compressor and an outdoor air temperature; and
the controller is configured to determine a target opening degree of the heating-side expansion valve based on the RPM of the compressor, the outdoor air temperature, and a discharge pressure of the compressor.

4. The vehicle HVAC system according to claim 3, wherein the controller is configured to determine an acceptable temperature difference based on a temperature decrease rate of the air flowing from the interior condenser to the rear seats of the cabin.

5. The vehicle HVAC system according to claim 4, wherein the controller is configured to calculate the temperature decrease rate based on a discharge mode in which the air is discharged through an outlet of the HVAC case, a flow rate of the air directed toward the rear seats of the cabin, and the outdoor air temperature.

6. The vehicle HVAC system according to claim 4, wherein the controller is configured to calculate the acceptable temperature difference by subtracting the temperature decrease rate from a reference temperature difference.

7. The vehicle HVAC system according to claim 6, wherein the controller is configured to determine a lower limit opening degree of the heating-side expansion valve based on the acceptable temperature difference, a temperature and flow rate of refrigerant flowing into the interior condenser, and a temperature and flow rate of the air passing by an exterior surface of the interior condenser.

8. The vehicle HVAC system according to claim 7, wherein the controller is configured to determine a first opening degree of the heating-side expansion valve by selecting a highest opening degree among the minimum opening degree, the target opening degree, and the lower limit opening degree.

9. The vehicle HVAC system according to claim 3, wherein the controller is configured to determine a second opening degree of the heating-side expansion valve by selecting the target opening degree.

10. A method for controlling a vehicle heating, ventilation, and air conditioning (HVAC) system including a compressor, an interior condenser located on a downstream side of the compressor and disposed in an HVAC case, a heating-side expansion valve located on a downstream side of the interior condenser, and a water-cooled heat exchanger located on a downstream side of the heating-side expansion valve, the method comprising:
determining, by a controller, an opening degree of the heating-side expansion valve based on a temperature difference between air flowing from the interior condenser to front seats of a cabin and air flowing from the interior condenser to rear seats of the cabin, and an amount of heat transferred from the interior condenser to the air.

11. The method according to claim 10, wherein determining the opening degree of the heating-side expansion valve includes:
determining, by the controller, a first opening degree of the heating-side expansion valve according to a uniform discharge temperature mode which is based on the temperature difference; or
determining, by the controller, a second opening degree of the heating-side expansion valve according to a heating boost mode which is based on an amount of heat released.

12. The method according to claim 10, wherein determining the opening degree of the heating-side expansion valve includes:
determining, by the controller, a minimum opening degree of the heating-side expansion valve based on revolutions per minute (RPM) of the compressor and an outdoor air temperature; and
determining, by the controller, a target opening degree of the heating-side expansion valve based on the RPM of the compressor, the outdoor air temperature, and a discharge pressure of the compressor.

13. The method according to claim 12, wherein determining the opening degree of the heating-side expansion valve includes determining, by the controller, an acceptable temperature difference based on a temperature decrease rate of the air flowing from the interior condenser to the rear seats of the cabin.

14. The method according to claim 13, wherein determining the acceptable temperature difference includes calculating, by the controller, the temperature decrease rate based on a discharge mode in which the air is discharged through an outlet of the HVAC case, a flow rate of the air directed toward the rear seats of the cabin, and the outdoor air temperature.

15. The method according to claim 13, wherein determining the acceptable temperature difference includes calculating, by the controller, the acceptable temperature difference by subtracting the temperature decrease rate from a reference temperature difference.

16. The method according to claim 15, wherein determining the opening degree of the heating-side expansion valve includes determining, by the controller, a lower limit opening degree of the heating-side expansion valve based on the acceptable temperature difference, temperature and flow rate of a refrigerant flowing into the interior condenser, and temperature and flow rate of the air passing by an exterior surface of the interior condenser.

17. The method according to claim 16, wherein determining the opening degree of the heating-side expansion valve includes determining, by the controller, a first opening degree of the heating-side expansion valve by selecting a highest opening degree among the minimum opening degree, the target opening degree, and the lower limit opening degree.

18. The method according to claim 12, wherein determining the opening degree of the heating-side expansion valve includes determining, by the controller, a second opening degree of the heating-side expansion valve by selecting the target opening degree.
